(19) United States
(12) Patent Application Publication
(10) Pub. No.: US 2013/0247778 A1
(43) Pub. Date: Sep. 26, 2013

(54) ENHANCED SAFETY FOR ELECTRICAL APPLIANCES SUCH AS TOASTERS

(71) Applicant: Raymond L. Legatti, Clearwater, FL (US)

(72) Inventor: Raymond L. Legatti, Clearwater, FL (US)

(73) Assignee: TECHNOLOGY RESEARCH CORPORATION, Clearwater, FL (US)

(21) Appl. No.: 13/849,530

(22) Filed: Mar. 24, 2013

Related U.S. Application Data
(60) Provisional application No. 61/615,215, filed on Mar. 24, 2012.

(51) Int. Cl. H02H 7/20; A47J 37/08

(52) U.S. Cl. CPC H02H 7/20; A47J 37/0814
USPC 99/327; 361/103

(57) ABSTRACT

Enhanced safety for an electrical appliance is provided by a circuit arrangement which removes power from a portion of the appliance, which if activated, could result in potentially dangerous conditions, while maintaining energization of other portions of the circuit which if de-activated could also result in potentially dangerous conditions. The circuit arrangement includes elements for detecting various types of dangerous or incipient dangerous conditions.

This application claims benefit of U.S. provisional application Ser. No. 61/615,215, filed Mar. 24, 2012.

### FIELD OF THE INVENTION

The present invention relates to a circuit arrangement which provides enhanced safety for electrical appliances such as toasters.

### BACKGROUND OF THE INVENTION

Protective circuit arrangements have been provided in the past to protect electrical devices such as electrical appliances and personnel or users of the devices when undesirable conditions develop within the device. Examples of such arrangements are set forth in the applicant's prior U.S. Pat. No. 6,525,914—Protection System for Devices Connected to an Alternating Current Electrical Power Supply, and U.S. Pat. No. 6,829,123—Device Safety System and Method. While the systems set forth in these patents various levels and types of protection for electrical devices, they are because of the number and type of electrical components involved and assemble costs, quite expensive when considered as a part of the overall cost of the device in which they are provided for protection.

Manufacturers of electrical appliances are continually trying to reduce the cost of manufacturing the appliances. As the cost of manufacturing the appliance decreases, the relative cost of protective circuit arrangements such as those set forth in the above mentioned patents becomes much greater, such that the manufacture becomes more reluctant to include them in the appliance. Rather than not include protective arrangements in an appliance, it is desirable to provide protection in a relatively less costly way.

While electrical appliances are designed to be reliable and safe to use, unsafe conditions can develop such as due to a failure in a component of the appliance, or due to miss-use of the appliance. For instance, an electrical toaster may present the following unsafe conditions. The elevator carriage may become jammed in the down position, thereby keeping the electrical heating elements activated. Excessive leakage currents from metal parts to electrically live parts such as the elements, may develop, such as caused by a build up of crumbs and grease between the metal parts and electrically live parts. Fire or flames developing within the toaster. A contact being made between the metal frame and electrically live parts by person sticking a metal object, such as a knife into the toaster. It is therefore desirability to include automatic protective features in certain consumer appliances that will contribute to both the protection of property and consumer safety.

### BRIEF SUMMARY OF THE INVENTION

It is an object of this invention to provide enhanced safety to consumer appliances, such as a toaster at a cost that will allow the general market product sales price be at a level the average consumer can afford. It is a further object of this invention to provide the maximum amount of safety at the lowest possible cost.

In accordance with this invention enhanced safety features are provided to toasters and other electrical appliances. Power is removed from the appliance, when a fire (flame) occurs within the appliance. Removing the power source is essential to limit the time duration in the event of such an occurrence. Further, for elevator type toasters it is important to maintain the elevator carriage in the down position to avoid the spreading of flaming debris outside of the toaster when the elevator carriage pops up. Further, electrical power is removed from the accessible live parts of the appliance when excessive electrical leakage currents occur, or an electrically conductive contact is established between the metal frame and live parts. Further, an audible or visual alarm may be provided in the event of any of the above mentioned situations.

### BRIEF DESCRIPTION OF THE DRAWINGS

FIG. 1 is a prior art schematic circuit diagram for a pop-up toaster;

FIG. 2 is a prior art schematic circuit diagram for a pop-up toaster provided with an alternative power disconnect relay

FIG. 3 is a circuit block diagram of the enhanced safety system for an electrical appliance in accordance with this invention; and

FIG. 4 is a detailed schematic circuit diagram for a pop-up toaster in accordance with a preferred embodiment of the present invention.

### DETAILED DESCRIPTION OF THE PREFERRED EMBODIMENT

In setting forth the detailed description of the drawings, the same numerals will be used for corresponding elements in the figures.

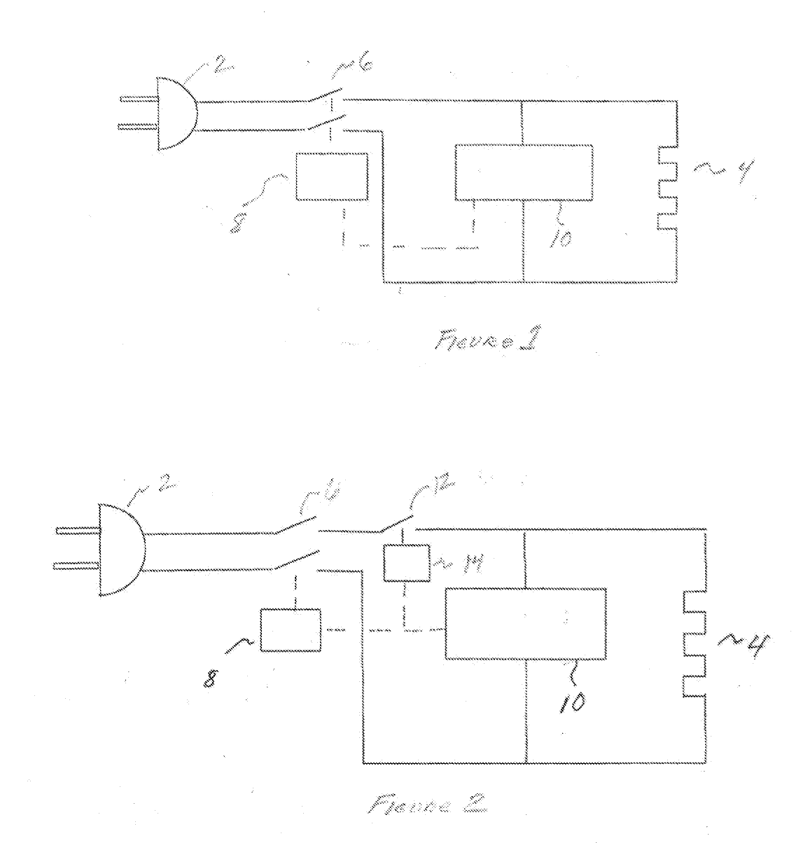

Referring to FIG. 1, a basic prior art toaster electrical circuit is shown. The circuit includes a plug 2 for connecting to an AC power source. Electrical heating elements 4 of the toaster are connected to the power source when the contacts 6 of a power switch 8 are closed. To initiate use of the toaster, the contacts 6 are closed, thereby energizing the heating elements 4 and a timer control 10. The opening of the contacts 6, by the power switch 8 is initiated by the release of the toaster elevator carriage by the timer control 10. The contacts 6 or the power switch 8 are mechanically or electrically locked in the closed position until the release of the toaster elevator carriage provides an input to the switch 8 to open the contacts 6.

Referring to FIG. 2, again a basic diagram of a typical “pop up” toaster is shown. The toast elevator carriage may be held down mechanically by a solenoid, or electrically by use of an electromagnet. Again, the carriage pop up release is controlled by the timer control 10. Contacts 12 of alternative power disconnect relay 14 are closed during normal operation of the appliance and open in response to a fault condition thereby removing power to the heater elements.

The addition of the alternative power disconnect relay 14 is necessary to ensure that the heater element power source will be removed under fault conditions in particular when the elevator carriage is maintained in the latched position, such as when a fire is initiated in the toaster compartment. Popping up of the elevator carriage could result in the distribution of flaming debris outside of the toaster. An example of another adverse condition would be that of a jammed down elevator carriage. Without the opening of the contacts over-heating and ignition of a fire in the toaster or of surrounding material would result. Upon detecting an adverse condition, an input signal is provided to the alternative power disconnect relay 14, to open the contacts 12, thereby removing power from the heating element 4. While the heating element 4 is de-activated, the power switch 8 remains activated, thereby preventing the release of the carriage, and the adverse consequences that could result from the release.

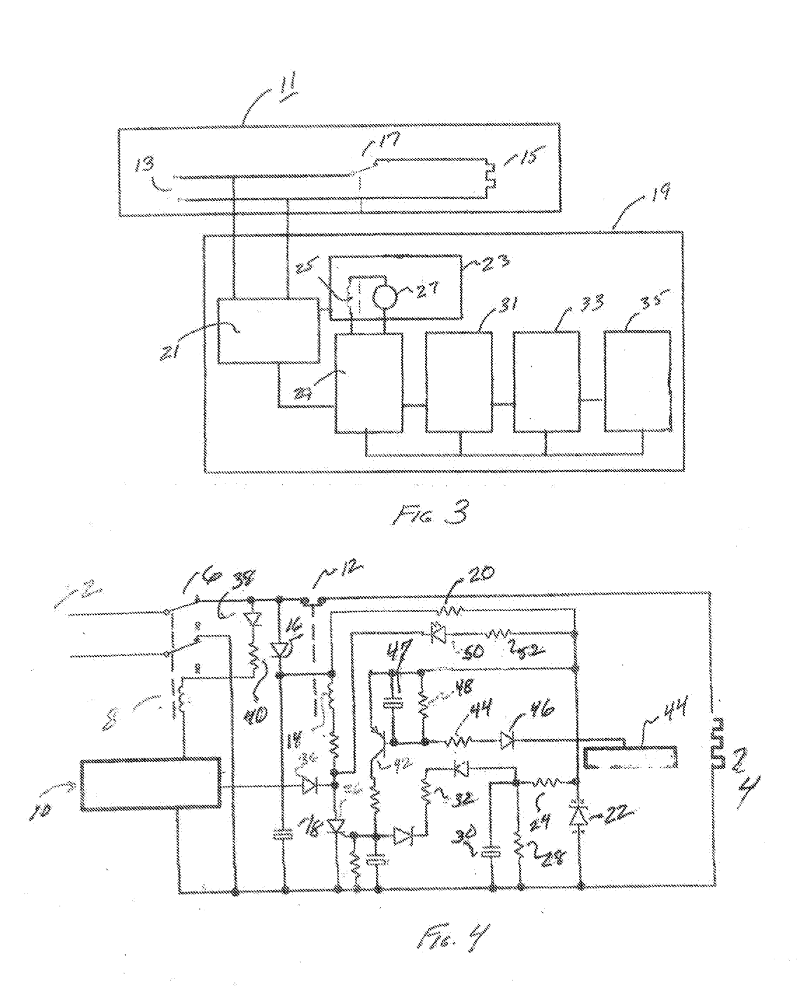

Referring to FIG. 3, a block diagram of an electrical appliance provided with the added protection in accordance with a preferred embodiment of this invention. The appliance being protected 11, includes connections 13 to a power supply, the appliance electrical load 15, and circuit interrupter contacts 17. The enhanced safety system of this invention shown as 19, includes a circuit power supply 21, which is activated from a power supply through connection 13. A circuit interrupter and alarm 23 includes a coil 25 for actuating the contact of a circuit breaker to remove power from the appropriate components of the appliance to terminate incipient or action dangerous conditions. An alarm 27 is also activated along with the coil 25. The energization of the coil 25 and alarm 27 is provided by a fault activation switch device 29. The power supplied to the coil 25 and the alarm 27 by the fault switch device 29, may vary in magnitude, such that the alarm 27 will be activated at a lower power level than the coil 25, to given advanced warning of a dangerous condition. As shown in FIG. 3, the fault activation switch device 29, may receive fault signals to activate the coil 25 and the alarm 27, from a variety of sensors. Sensors shown are a flame sensor 31, a leakage current sensor 33, and other sensor 35. In an alternative circuit arrangement, the coil of alternative power disconnect relay 14 may be normally activated and the coil de-activated with detection of a fault.

The flame sensor 31 includes a light responsive element which is positioned in the appliance to detect light indicative of an incipient or actual fault condition. Reflectors, refractors, or other devices may be included in the appliance to direct the light indicative of an incipient or actual fault condition to the light responsive element.

The leakage current sensor 33, configured to sense a leakage current between the live circuit components within the appliance an the metal housing. This leakage current may be due to electrical insulation failure, or the insertion of a metal object in the appliance which establishes a conductive path between live circuit elements and the metal housing. The detection and alarm indication of excessive electrical leakage currents within the appliance could well prevent a serious hazardous event from occurring, and may provide early warning of pending fault conditions such as, insulation failure, carbonized path, and tracking that can lead to dangerous electrical arcing. Further, the build up of grease, crumbs or other electrically conductive substances would provide the consumer user a reason to clean the appliance.

The other sensor 35, is intended to indicate that sensors which could detect other types of incipient or actual dangerous conditions in the appliance may be provided.

Referring to FIG. 4, a typical basic toaster circuit is shown with details of the added protection and visual display circuit in accordance with a preferred embodiment of this invention. This added protection is provided in the event of: Excessive leakage currents or contact between metal frame and live parts, compartment flame (fire), and a jammed elevator carriage. As in the typical pop up toaster, power is provided to the toaster elements 4 through the closed contacts 6 when the spring loaded elevator carriage is held in the down position by the action of either a mechanical latch or an activated electromagnet. The timer controller 10 will release the elevator carriage to it's up position when the time period for the toaster setting has been achieved, and will remove power from a solenoid 8, to open contacts I, removing power from all circuits within the toaster.

Referring to the specific circuitry of the preferring embodiment of this invention, a DC power supply includes a diode 16 a capacitor 18, and a voltage regulator formed by resistor 20 and zener diode 22, which are standard and well known circuits.

In the event of jamming of the elevator carriage in the down position the heating elements 4 may continue to be activated and a fire could result. Should this situation occur, the timer control 10 can be suitably connected to provide a signal to the gate of SCR 26 thus energizing the coil of the alternative power disconnect relay 14 and remove power from the heating elements 4 by opening contacts 12.

If a flame or fire occurs within the toaster compartments a light sensitive resistor or similar light sensitive component 24 positioned within the toaster will detect the scattered or emitted light that is created and gate SCR 26 through a time delay circuit which includes resistor 28, capacitor 30, diode 16, capacitor 18, zener diode 22, and resistor 32, into a conductive state energizing the coil of alternate power disconnect relay 14 and removing the power source from the heating elements 4 by opening contacts 12. It is important to maintain the elevator carriage in the down position to prevent the spreading of flaming debris. This is accomplished is the case of a mechanically latched solenoid 8 arrangement by removing the power source to solenoid 8 or the timer control 10 when the coil of alternate power disconnect relay 14 is activated. Alternatively, in the case of a solenoid 8 electro magnet arrangement power may be maintained to the coil 8 through a diode 36, a diode 38 and a resistor 40.

It is also desirable to remove power from the toast if any contact is made between the metal casing of the toaster and electrically live parts. For example, a user of the toaster might try to dislodge a slice of bread with an electrically conductive implement. Removal of the power is accomplished by detecting low level electrical current flow between the metal casing of the toaster and an electrically live part. A contact between the metal casing 44 and an electrically live part is detected by the circuit consisting of resistor 44 and diode 46. The detection of a low level electrical current through resistor 44 and diode 46 is applied as a forward bias to transistor 42, thereby providing a gating signal to SCR 26 and energizing the solenoid of alternate power disconnect relay 14, opening contacts 12 to de-energize the heating elements 4.

To further describe the circuit of the preferred embodiment of this invention, capacitor 47 and resistor 48 provide noise and detection level control. A series circuit of a light emitting diode 50 and a resistor 52 is connected in parallel with alternate power disconnect relay 14, thereby providing a visual fault display. An audible fault indication could be provided by using a piezo or similar type alarm connected in place of, or in parallel with the light emitting diode 50 and resistor 52.

While a preferred embodiment of the circuit arrangement of this invention which provides enhanced safety for electrical appliances such as toasters has been shown, it should be apparent to those skilled in the art that what has been shown and described is considered at present to be a preferred embodiment of the circuit arrangement and system of this invention. While a preferred embodiment of the circuit arrangement of this invention has been shown and described other circuit arrangements are contemplated by this invention. In accordance with the Patent Statutes, changes may be made in the enhance safety arrangement for electrical appliances of this invention without actually departing from the true spirit and scope of this invention. The appended claims are intended to cover all such changes and modifications which fail in the true spirit and scope of this invention.

1. A circuit arrangement for providing enhanced safety for an electrical appliance having an electrical load comprising:
A. a power switch having an actuating mechanism for opening and closing contacts connecting the appliance to a power source,
B. the contacts being closed to energize the appliance when a user initiates use of the appliance,
C. a timing device being actuated upon energization of the appliance, said timing device actuating opening said contacts to de-energize the appliance after a predetermined time,
D. an alternative power disconnect device for de-energizing the electrical load of the electrical appliance,
E. a sensing device for detecting an abnormal condition in the electrical appliance, the detection of an abnormal condition by said sensing device energizing said solenoid of said alternative power disconnect device to de-energize the electrical load of the electrical appliance, while maintain energization of the timing device to maintain the contacts of the power switch in their closed position.

2. The circuit arrangement for providing enhanced safety for an electrical appliance having an electrical load of claim 1, wherein the sensing device is light sensitive.

3. The circuit arrangement for providing enhanced safety for an electrical appliance having an electrical load of claim 2, including a switching device, which when in its conductive state energizes said alternate power disconnect device.

4. The circuit arrangement for providing enhanced safety for an electrical appliance having an electrical load of claim 3, wherein the sensing of light by said light sensitive device provides a signal to said switching device to cause it to enter its conductive state, whereby power is removed from the electrical load.

5. The circuit arrangement for providing enhanced safety for an electrical appliance having an electrical load of claim 1, the sensing device is a semiconductor device which is biased to its conductive state by the occurrence of a low level electrical current flow between the metal casing of the appliance and an electrically live part, to provide a signal to said switching device to cause it to enter its conductive state, whereby power is removed from the electrical load.

6. A circuit arrangement for providing enhanced safety for an electrical appliance having an electrical load comprising:
A. a power switch having an actuating mechanism for opening and closing contacts connecting the appliance to a power source,
B. the contacts being closed to energize the appliance when a user initiates use of the appliance,
C. a timing device being actuated upon energization of the appliance, said timing device actuating opening said contacts to de-energize the appliance after a predetermined time,
D. an alternative power disconnect device for de-energizing the electrical load of the electrical appliance,
E. a sensing device for detecting an abnormal condition in the electrical appliance, the detection of an abnormal condition by said sensing device, to cause said alternative power disconnect device to de-energize the electrical load of the electrical appliance, and
F. an alarm device, said alarm device providing an alarm when said sensing device detects an abnormal condition.

7. The circuit arrangement for providing enhanced safety for an electrical appliance having an electrical load of claim 2, wherein said electrical appliance is a pop up type toaster having heating elements as the electrical load and a pop up carriage, including a switching device, which when in its conductive state causes said alternate power disconnect device to remove power to the heating elements, and the pop up carriage remains in the lower position.
